(19) United States
(12) Patent Application Publication
(10) Pub. No.: US 2011/0037748 A1
(43) Pub. Date: Feb. 17, 2011

(54) LIGHT EMITTING DEVICE AND DRIVING METHOD FOR THE SAME

(76) Inventor: Mun-Seok Kang, Yongin-si (KR)

Correspondence Address: CHRISTIE, PARKER & HALE, LLP, PO BOX 7068, PASADENA, CA, 91109-7068, US

(21) Appl. No.: 12/846,628

(22) Filed: Jul. 29, 2010

(30) Foreign Application Priority Data
Aug. 14, 2009 (KR) 10-2009-0075426

(51) Int. Cl. G09G 5/00

(52) U.S. Cl. 345/211

(57) ABSTRACT

A dimming signal having brightness information of a plurality of light emission pixels is generated by reading the input video signal and the input image control signal. A plurality of light emission data voltages corresponding to the dimming signal are generated. A scanning start signal including a plurality of first pulses and second pulses being for respectively controlling a generation time of the plurality of first scan signals and the plurality of second scan signals applied to the plurality of scan lines is generated. A horizontal synchronizing start signal including a plurality of third pulses respectively synchronized with the plurality of first pulses for controlling the time for applying the plurality of light emission data voltages to the plurality of scan lines, and a plurality of fourth pulses having a phase differing from the second pulses, is generated.

### CROSS-REFERENCE TO RELATED APPLICATION

This application claims priority to and the benefit of Korean Patent Application No. 10-2009-0075426, filed in the Korean Intellectual Property Office on Aug. 14, 2009, the entire contents of which are incorporated herein by reference.

### BACKGROUND

1. Field

The following description relates to a light emitting device, and a method of driving the same. More particularly, the following description relates to a light emitting device that emits light utilizing electron emission characteristics due to an electric field, and a method of driving the same.

2. Description of the Related Art

A liquid crystal display (LCD), which is a kind of flat panel display, is a display device that displays an image by changing a light transmission amount of a pixel by utilizing dielectric anisotropy of liquid crystal having a twist angle that changes according to an applied voltage. Compared with a cathode ray tube, which is a typical image display device, the LCD has a merit of decreasing weight, thickness, and power consumption. The LCD includes a liquid crystal panel assembly, and a light emitting device that is positioned at the rear side of the liquid crystal panel assembly to provide light to the liquid crystal panel assembly.

When the liquid crystal panel assembly is formed with an active liquid crystal panel assembly, the liquid crystal panel assembly includes a pair of transparent substrates, a liquid crystal layer that is positioned between the transparent substrates, a polarizing plate that is disposed at an outer surface of the transparent substrates, a common electrode that is provided in an internal surface of one transparent substrate, pixel electrodes and switches that are provided in an internal surface of the other transparent substrate, and a color filter that provides red, green, and blue colors to three sub-pixels constituting a pixel. The liquid crystal panel assembly receives light emitted from the light emitting device and allows the light to be transmitted or blocked by the action of the liquid crystal layer to thus display a set or predetermined image.

Since the reaction speed of liquid crystal may be longer than one frame period, a motion blur phenomenon may occur in the LCD when an image having fast motion for each frame is displayed so that a dim after-image is displayed on a screen. In order to solve the motion blur phenomenon, an impulsive method is used so that light sources of the light emitting device are turned on only when an image is displayed for one frame and the light sources are turned off the rest of the time. In this way, an after-image of a previous frame is eliminated so that the motion blur phenomenon can be improved. However, the impulsive method has a problem of causing a flicker phenomenon so that when a still image is realized on the screen, the image flickers.

The above information disclosed in this Background section is only for enhancement of understanding of the background of the invention and therefore it may contain information that does not form the prior art that is already known in this country to a person of ordinary skill in the art.

### SUMMARY OF THE INVENTION

An aspect of an embodiment of the present invention is directed toward a light emitting device that is capable of decreasing and/or eliminating a motion blur phenomenon and/or a flicker phenomenon, and a driving method thereof.

According to an embodiment of the present invention, a light emitting device for providing a light source to a display for displaying an image according to an input video signal and an input video control signal is presented. The light emitting device includes a display unit, a controller, a scan driver, and a column driver. The display unit includes a plurality of scan lines, a plurality of column lines, and a plurality of light emission pixels for providing a light source to at least one pixel of a display, wherein the plurality of scan lines are sequentially applied with a plurality of first scan signals and a plurality of second scan signals during one frame period, and the plurality of column lines are applied with a plurality of light emission data voltages. The controller is configured to generate a plurality of dimming signals having brightness information for the plurality of light emission pixels by reading the input video signal and the input image control signal, to generate the plurality of light emission data voltages corresponding to the dimming signals, to generate a scanning start signal including a plurality of first pulses and a plurality of second pulses, the plurality of first pulses and the plurality of second pulses being for respectively controlling a generation time of the plurality of first scan signals and the plurality of second scan signals, and to generate a horizontal synchronizing start signal including a plurality of third pulses respectively synchronized with the plurality of first pulses and a plurality of fourth pulses having a phase differing from the plurality of second pulses. The scan driver is for sequentially applying the plurality of first scan signals and the plurality of second scan signals to the plurality of scan lines according to the scanning start signal. The column driver is for applying the plurality of light emission data voltages to the plurality of column lines according to the horizontal synchronizing start signal.

The controller includes a local brightness controller configured to generate a plurality of motion flag signals, having motion information of regions of the display, to respectively correspond to the plurality of light emission pixels, and to generate a plurality of ratio control signals having division ratio information of the plurality of dimming signals respectively according to the plurality of motion flag signals, and a light emission controller that divides the plurality of dimming signals to be a plurality of first divided dimming data corresponding to the first scan signals and a plurality of second divided dimming data corresponding to the second scan signals according to the plurality of ratio control signals. The local brightness controller increases or decreases a ratio of the plurality of first divided dimming data and the plurality of second divided dimming data with respect to the plurality of dimming signals according to the plurality of motion flag signals. The local brightness controller is configured to generate a synchronization signal for dividing the plurality of dimming signals by using the input video control signal and a light emission control signal for controlling light emission of the plurality of light emission pixels.

The light emission controller includes a data processor that is configured to divide the dimming signal to the plurality of first divided dimming data and the plurality of second divided dimming data according to the plurality of ratio control signals, a plurality of memories respectively including a first sub-memory and a second sub-memory in which the plurality of first divided dimming data and the plurality of second divided dimming data are configured to be respectively stored by one frame unit, and a frame buffer unit that is configured to selectively read or write the plurality of first divided dimming data and the plurality of second divided dimming data from the plurality of memories according to first a counting signal and a second counting signal generated in accordance with the synchronization signal. The frame buffer unit is configured to synchronize the first counting signal in accordance with the synchronization signal, and synchronize the second counting signal such that the second counting signal is delayed for about a half period with respect to the first counting signal. Further, the first counting signal and the second counting signal include digital data for indicating a number of the plurality of memories and are configured to be iteratively changed by the number of the plurality of memories. The frame buffer unit is configured to write the plurality of first divided dimming data and the plurality of second divided dimming data in an order of the plurality of memories according to the first counting signal. The frame buffer unit is configured to read the plurality of first divided dimming data from a first memory that has finished writing the plurality of first divided dimming data and the plurality of second divided dimming data among the plurality of memories according to the first counting signal, and is configured to read the plurality of second divided dimming data from the first memory according to the second counting signal. The frame buffer unit is configured to alternately read the plurality of first divided dimming data and the plurality of second divided dimming data.

The light emission controller further includes a control signal generator for generating a scan driving control signal and a column driving control signal by utilizing the light emission control signal. The light emitting device further includes a scan driver for applying the plurality of first scan signals and the plurality of second scan signals to the plurality of scan lines according to the scan driving control signal. Each frame period is divided into at least two fields, and the scan driver is configured to sequentially apply the plurality of first scan signals during to a first field of the at least two fields to the plurality of scan lines and sequentially apply the plurality of second scan signals during to a second field of the at least two fields to the plurality of scan lines. The first field includes a period during which the scan driver is configured to alternately apply the plurality of scan signals of a current frame and the plurality of second scan signals of a directly previous frame. The second field includes a period in which the scan driver is configured to alternately apply the plurality of second scan signals and the plurality of first scan signals of a current frame.

The light emitting device further includes a column driver configured to apply a light emission data voltage of the plurality of light emission data voltages to the plurality of column lines during a period corresponding to the plurality of first divided dimming data and the plurality of second divided dimming data according to the column driving control signal.

According to another embodiment of the present invention, a driving method of a light emitting device including a plurality of light emission pixels for providing a light source to at least one pixel of a display configured to display an image according to an input video signal and an input video control signal, a plurality of scan lines, and a plurality of column lines is presented. The method includes generating a dimming signal having brightness information for the plurality of light emission pixels by reading the input video signal and the input image control signal; generating a plurality of light emission data voltages corresponding to the dimming signal, generating a scanning start signal including a plurality of first pulses and second pulses for respectively controlling a generation time of a plurality of first scan signals and a plurality of second scan signals applied to the plurality of scan lines, and generating a horizontal synchronizing start signal including a plurality of third pulses respectively synchronized with the plurality of first pulses for controlling a time for applying the plurality of light emission data voltages to the plurality of scan lines, and a plurality of fourth pulses having a phase differing from the second pulses.

The generating of the dimming signal having the brightness information includes generating a plurality of motion flag signals having motion information for regions of the display, to respectively correspond to the plurality of light emission pixels, generating a plurality of ratio control signals having division ratio information of the dimming signal according to the plurality of motion flag signals, and dividing the dimming signal to be a plurality of first divided dimming data corresponding to the first scan signal and a plurality of second divided dimming data corresponding to the second scan signal according to the plurality of ratio control signals, wherein the dimming signal includes the plurality of first dividing dimming data and the plurality of second divided dimming data. The dividing of the dimming signal to the plurality of first divided dimming data and the plurality of second divided dimming data includes increasing or decreasing a ratio of the plurality of first divided dimming data with respect to the dimming signal according to the plurality of motion flag signals.

The input video control signal includes a vertical synchronization signal, and the driving method further includes generating a synchronization signal that is synchronized with the vertical synchronization signal, generating a first counting signal synchronized with the synchronization signal and generating a second counting signal synchronized at a time that is delayed by about a half period from the synchronization signal, and selectively reading and writing the plurality of first divided dimming data and the plurality of second divided dimming data according to the first counting signal and the second counting signal. The selective reading and writing of the plurality of first divided dimming data and the plurality of second divided dimming data includes writing the plurality of first divided dimming data and the plurality of second divided dimming data of one frame unit according to the first counting signal; reading the plurality of first divided dimming data according to the first counting signal when the writing of the first divided dimming data and the plurality of second divided dimming data of one frame unit is finished; and reading the plurality of second divided dimming data according to the second counting signal. The alternately reading of the plurality of first divided dimming data and the plurality of second divided dimming data is repeated.

As described above, according to embodiments of the present invention, motion blur and flicker phenomena of the display may be improved.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram of a liquid crystal display (LCD) according to an exemplary embodiment of the present invention.

FIG. 2 is a detailed block diagram of a local brightness controller of FIG. 1 according to an exemplary embodiment of the present invention.

FIG. 3 is an equivalent circuit diagram of a pixel PX of FIG. 1 according to an exemplary embodiment of the present invention.

FIG. 4 is a detailed block diagram of a light emission controller 110 of FIG. 1 according to an exemplary embodiment of the present invention.

FIG. 5 is a timing diagram showing a scanning start signal input to a scan driver and a horizontal synchronizing start signal input to a column driver according to an exemplary embodiment of the present invention.

FIG. 6 is a block diagram of a column driver of FIG. 1 according to an exemplary embodiment of the present invention.

FIG. 7 is a timing diagram showing an operation of a light emission controller 110 according to an exemplary embodiment of the present invention.

FIG. 8 is a timing diagram showing a motion flag signal MS, a dimming signal DS, a ratio control signal RC, first divided dimming data DSS1, DSS3, and DSS5, and second divided dimming data DSS2, DSS4, and DSS6, according to an exemplary embodiment of the present invention.

### DETAILED DESCRIPTION

In the following detailed description, only certain exemplary embodiments of the present invention are shown and described, simply by way of illustration. As those skilled in the art would realize, the invention may be embodied in many different forms and should not be construed as being limited to the embodiments set forth herein. Like reference numerals designate like elements throughout the specification.

Throughout this specification and the claims that follow, when it is described that a first element is “coupled” to a second element, the first element may be “directly coupled” to the second element or “electrically coupled” to the second element through one or more third elements. In addition, unless explicitly described to the contrary, the word “comprise” and variations such as “comprises” or “comprising” will be understood to imply the inclusion of stated elements but not the exclusion of any other elements.

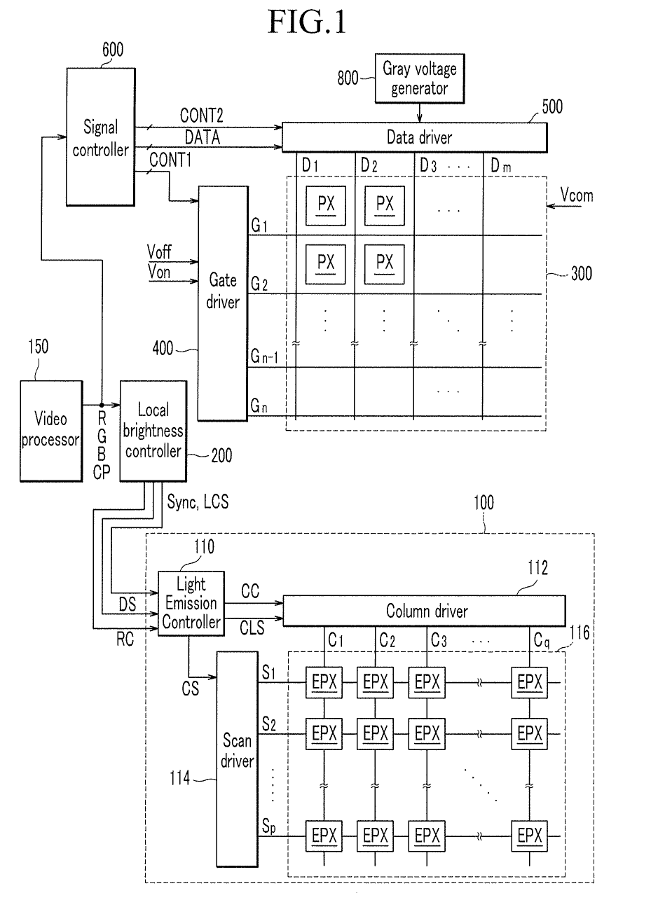

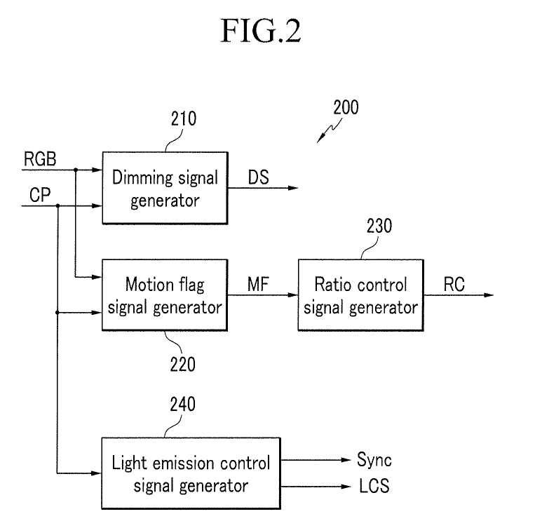

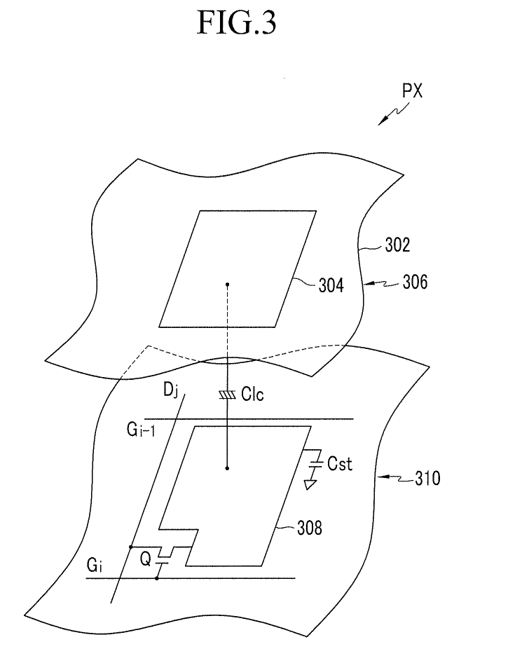

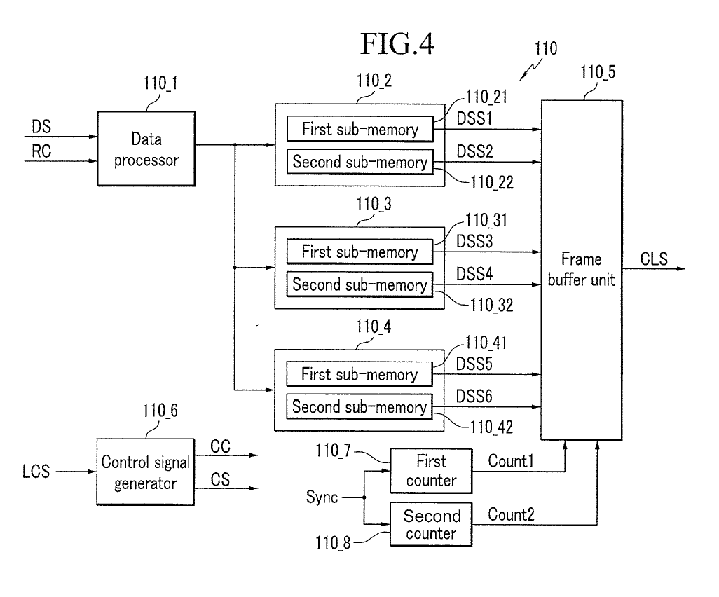

FIG. 1 is a block diagram of a liquid crystal display (LCD) according to an exemplary embodiment of the present invention, FIG. 2 is a detailed block diagram of a local brightness controller of FIG. 1, FIG. 3 is an equivalent circuit diagram of a pixel PX of FIG. 1, and FIG. 4 is a detailed block diagram of a light emission controller 110 of FIG. 1.

Referring to FIG. 1, an LCD according to the exemplary embodiment of the present invention includes a light emitting device 100, a video processor 150, a local brightness controller 200, a liquid crystal panel assembly 300, a gate driver 400, a data driver 500, a gray voltage generator 800, and a signal controller 600.

The video processor 150 receives an image signal transmitted from various media, and converts the received image signal to input video signals R, G, and B that correspond to resolution of the LCD and an input video control signal CP for image display according to the input image signal. The input video signals R, G, and B and the input image control signal CP are input to the local brightness controller 200 and the signal controller 600. The input video signals R, G, and B include luminance information of each pixel PX, and luminance is expressed by a set or predetermined number of gray levels, for example, gray levels of 1024=2¹⁰, 256=2⁸, or 64=2⁶. The input image control signal CP includes input video signals R, G, and B, and control signals Hsync, Vsync, MCLK, and DE for displaying the input video signals R, G, and B.

Referring to FIG. 2, the local brightness controller 200 includes a dimming signal generator 210, a motion flag signal generator 220, a ratio control signal generator 230, and a light emission control signal generator 240. The dimming signal generator 210 reads the input video signals R, G, and B and the input image control signal CP to determine a degree of brightness of a plurality of light emission pixels EXPs of the light emitting device 100. The dimming signal generator 210 generates a dimming signal DS where a plurality of dimming data are arranged. Here, the plurality of dimming data respectively represent a degree of brightness of the light emitting pixels EXPs.

In further detail, the dimming signal generator 210 reads the input video signal R, G, and B and the input image control signal CP to detect the highest gray level among a plurality of pixels PXs that correspond to one light emission pixel EPX, and determines a gray level of a light emission pixel EPX according to the detected gray level. In addition, the dimming signal generator 210 generates the dimming signal DS that represents the determined gray level. In the exemplary embodiment of the present invention, the dimming signal DS utilized as grayscale data of one light emitting pixel EXP is realized by the dimming data of 8 bits, and has a structure in which a plurality of dimming data of a plurality of light emitting pixels EPX of one frame unit are arranged in a line. However, the present invention is not limited thereto.

The motion flag signal generator 220 reads the input video signals R, G, and B and the input image control signal CP to extract motion information for a plurality of areas (e.g., regions) of the liquid crystal panel assembly 300, respectively corresponding to the plurality of light emitting pixels EPX, so as to generate a plurality of motion flag signals MF. In further detail, the motion flag signal generator 220 detects a degree of luminance variation of input video signals R, G, and B that respectively correspond to the plurality of areas (e.g., regions) of the liquid crystal panel assembly 300, to respectively correspond to the plurality of light emitting pixels EXPs. It is determined that, when the luminance variation is significant, the corresponding area has motion, and when the luminance variation is insignificant, the corresponding area does not have motion. In the exemplary embodiment of the present invention, a high-level motion flag signal MF is generated corresponding to the area having motion and a low-level motion flag signal MF is generated corresponding to the area having no motion. However, other embodiments of the present invention are not limited thereto, and motion flag signals MFs may have different levels depending on motion.

The ratio control signal generator 230 generates a plurality of ratio control signals RC according to respective motion flag signals MF of the plurality of light emitting pixels EXP. The ratio control signal RC implies a ratio that divides dimming data of each light emitting pixel EXP into first divided dimming data and the plurality of second divided dimming data. The light emitting device 100 according to the exemplary embodiment of the present invention transmits a plurality of scan signals to a plurality of scan lines S1 to Sp twice for each frame. Each frame includes a first field including a period for the first transmission of the plurality of scan signals to the plurality of scan lines S1 to Sp, and a second field including a period for the second transmission of the plurality of scan signals to the plurality of scan lines S1 to Sp. That is, for example, the plurality of scan lines may be sequentially applied with a plurality of first scan signals and a plurality of second scan signals during one frame period so that the plurality of scan signals are applied to the plurality of scan lines S1 to Sp twice during the one frame period. The light emitting device 100 controls the plurality of light emitting pixels EXPs to emit light according to the plurality of first divided dimming data and the plurality of second divided dimming data during each field. The dimming data according to the exemplary embodiment of the present invention is divided by one frame unit, and indicates a light emission time of the plurality of light emitting pixels EXPs that form the light emitting device 100 during one frame. In addition, the plurality of first divided dimming data and the plurality of second divided dimming data indicate a light emission time of the plurality of light emitting pixels EXPs during each field. Luminance expressed by light emission of the plurality of light emitting pixels EXPs during the first field and the second field according to the plurality of first divided dimming data and the plurality of second divided dimming data is substantially the same as luminance expressed by light emission of the plurality of light emitting pixels EXPs during one frame according to the plurality of dimming data that has not been divided into first divided dimming data and second divided dimming data. Therefore, the light emitting device 100 controls a degree of light emission of the plurality of light emitting pixels EXPs by controlling the light emission time according to the plurality of first divided dimming data and the plurality of second divided dimming data during each period of the first field and the second field.

In further detail, the ratio control signal RC is a quantization of a ratio applied for division of the dimming data to the first divided dimming data and the plurality of second divided dimming data, and is substantially the same as a ratio of the first divided dimming data with respect to the dimming data. For control of a division ratio, the number of bits of the dimming signal DS may be increased or decreased. In the exemplary embodiment of the present invention, a pulse width of a plurality of light emission data voltages is determined according to the plurality of first divided dimming data and the plurality of second divided dimming data such that a degree of brightness of the plurality of light emission pixels EPXs is determined. When both the ratio control signal RC is 50%, and the motion flag signal MF is at a high level, the ratio control signal RC is increased by units of 10%. When the motion flag signal MF is at a low level, the ratio control signal RC is decreased by units of 10%. When the high-level motion flag signal MF is sequentially generated two times, the ratio control signal RC becomes 70%. If a current ratio control signal RC is 70% and the motion flag signal MF is low level, the ratio control signal RC becomes 60% after being decreased by a unit of 10%. However, the ratio control signal RC is not decreased below 50%. As described, the ratio control signal RC varies within 50% to 100% according to the motion flag signal MF.

The light emission control signal generator 240 generates a control signal for driving the light emitting device by using an input image control signal CP. The light emission control signal generator 240 generates a synchronization signal Sync and a light emission control signal LCS for dividing a frame according to the input image control signal CP. The synchronization signal Sync is a control signal for generating a light emission signal CLS that determines a light emission period, and the light emission control signal LCS is a control signal for operation of the light emitting device 100 according to an adaptive scan method. In order to realize the adaptive scan method, frequency modulation of the input image control signal CP is required. In further detail, the light emission control signal LCS includes signals that are modulated to twice the frequency of a vertical synchronization signal Vsync and a horizontal synchronization signal Hsync. The adaptive scan method will be described in further detail below.

Referring back to FIG. 1, the liquid crystal panel assembly 300 includes a plurality of signal lines G1 to Gn and D1 to Dm and a plurality of pixels PXs substantially arranged in a matrix format in an equivalent circuit view. The signal lines G1 to Gn and D1 to Dm include a plurality of gate lines G1 to Gn for transmission of a gate signal (referred to as a scan signal) and a plurality of data lines D1 to Dm. The gate lines G1 to Gn are extended in a row direction and substantially parallel with each other, and the data lines D1 to Dm are extended in a column direction and substantially parallel with each other.

Referring to FIG. 3, each pixel PX, for example a pixel PXij connected to the i-th (i=1, 2, n) gate line Gi and the j-th (j=1, 2, m) data line Dj, includes a switch Q connected to the signal lines Gi and Dj, a liquid crystal capacitor Clc connected to the switch Q, and a storage capacitor Cst. The storage capacitor Cst may be omitted as necessary.

The switch Q is a three-terminal element such as a thin film transistor that is provided in a lower display panel 310, and a control terminal thereof is connected to the gate line Gi, an input terminal thereof is connected to the data line Dj, and an output terminal thereof is connected to the liquid crystal capacitor Clc and the storage capacitor Cst.

The liquid crystal capacitor Clc uses a pixel electrode 308 of the lower display panel 310 and a common electrode 302 of an upper display panel 306 as two terminals, and a liquid crystal layer between the two electrodes 302 and 308 functions as a dielectric material. The pixel electrode 308 is connected to the switch Q, and the common electrode 302 is formed in a front surface of the upper display panel 306 and receives a common voltage Vcom. In another embodiment, the common electrode 302 may be provided in the lower display panel 310, and in this case, at least one of the two electrodes 302 and 308 may be formed in a linear shape or a bar shape.

The storage capacitor Cst for assisting the functions of the liquid crystal capacitor Clc is formed by overlapping a separate signal line (not shown) and the pixel electrode 308 that are provided in the lower display panel 310 while disposing an insulator therebetween, and a set or predetermined voltage such as a common voltage Vcom is applied to the separate signal line. However, the storage capacitor Cst may be formed by overlapping the pixel electrode 308 with a front end gate line Gi-1 directly on the pixel electrode 308 using an insulator as an intermediary.

In order to embody color display, by allowing each pixel PX to inherently display one of primary colors (spatial division) or allowing each pixel PX to sequentially and alternately display primary colors (temporal division), a desired color can be recognized with a spatial or temporal combination of the primary colors. The primary colors may include, for example, three primary colors of light, such as red, green, and blue colors. FIG. 3 illustrates an example of a spatial division and shows that each pixel PX has a color filter 304 representing one of primary colors in an area of the upper display panel 306 corresponding to the pixel electrode 308. In another embodiment, the color filter 304 may be disposed in an upper part or a lower part of the pixel electrode 308 of the lower display panel 310. At least one polarizer is provided in the liquid crystal panel assembly 300.

Referring back to FIG. 1, the gray voltage generator 800 generates all gray voltages or gray voltages of a limited number (hereinafter, referred to as “reference gray voltages”) that are related to transmittance of the pixel PX. The reference gray voltages may have a positive value and a negative value relative to a common voltage Vcom.

The gate driver 400 is connected to gate lines G1 to Gn of the liquid crystal panel assembly 300 to apply a gate signal composed of a combination of a gate-on voltage Von and a gate-off voltage Voff to the gate lines G1 to Gn.

The data driver 500 is connected to data lines D1 to Dm of the liquid crystal panel assembly 300, selects a gray voltage from the gray voltage generator 800, and applies the gray voltage as a data voltage to the data lines D1 to Dm. However, when the gray voltage generator 800 provides only reference gray voltages of a limited number instead of providing all gray voltages, the data driver 500 generates a desired data voltage by dividing a reference gray voltage.

The signal controller 600 controls the gate driver 400 and the data driver 500. The signal controller 600 appropriately processes the input video signals R, G, and B to correspond to an operation condition of the liquid crystal panel assembly 300 based on the input video signals R, G, and B and the input control signal CP that are received from the video processor 150, thereby generating a digital video signal DATA, a gate control signal CONT1, and a data control signal CONT2. The signal controller 600 transmits the generated gate control signal CONT1 to the gate driver 400, and transmits the data control signal CONT2 and the processed digital video signal DATA to the data driver 500.

The gate control signal CONT1 includes a scanning start signal STV that instructs the scanning start and at least one clock signal that controls an output period of a gate-on voltage Von. The gate control signal CONT1 may further include an output enable signal OE that limits a duration time of a gate-on voltage Von.

The data control signal CONT2 includes a horizontal synchronization start signal STH that notifies the start of transmitting a digital video signal DATA for pixels PX of a row to the data driver 500, and a load signal LOAD that is utilized to control the application of an analog data voltage to the data lines D1 to Dm. The data control signal CONT2 may further include a reversal signal RVS that inverts the polarity of a data voltage (hereinafter, “polarity of a data voltage to a common voltage” is abbreviated to “polarity of a data voltage”) to a common voltage Vcom.

The data driver 500 generates an analog data voltage by selecting a gray voltage corresponding to the digital video signal DATA and applies the analog data voltage to the corresponding data lines D1 to Dm.

The gate driver 400 applies a gate-on voltage Von to the gate lines G1 to Gn according to the gate control signal CONT1 from the signal controller 600, thereby turning on a switch Q that is connected to the gate lines G1 to Gn. Accordingly, a data voltage that is applied to the data lines D1 to Dm is applied to the corresponding pixel PX through the turned on switch Q.

The difference between a data voltage and a common voltage Vcom that are applied to the pixel PX is represented as a charge voltage, i.e., a pixel voltage of the liquid crystal capacitor Clc. Liquid crystal molecules may have different arrangements according to the magnitude of the pixel voltage, and thus polarized light of light that passes through the liquid crystal layer may change. The change of the polarized light is represented with a transmittance change of light by a polarizer, and thus the pixel PX displays luminance that is represented by a gray level of a digital video signal DATA.

By repeating such a process using one horizontal period (may be called “1H”, and is the same as a period of a horizontal synchronization signal Hsync and a data enable signal DE) in units, a gate-on voltage Von is sequentially applied to all gate lines G1 to Gn and a data voltage is applied to all pixels PX, thereby displaying an image of a frame.

The light emitting device 100 includes a light emission controller 110, a column driver 112, a scan driver 114, and a display unit 116. As shown in FIG. 4, the light emission controller 110 includes a data processor 110_1, a plurality of first to third memories 110_2, 1103 and 110_4, a frame buffer unit 1105, and a control signal generator 110_6. The data processor 110_1 divides a plurality of dimming data of one frame unit according to the corresponding ratio control signal RC to generate a plurality of first divided dimming data and a plurality of second divided dimming data. The data processor 110_1 transmits the plurality of first divided dimming data and the plurality of second divided dimming data to a corresponding memory among the plurality of first to third memories 110_2, 110_3 and 110_4. That is, the first memory 110_2 stores a plurality of first divided dimming data DSS1 and a plurality of second divided dimming data DSS2 of the n-th frame, and the second memory 110_3 stores a plurality of first divided dimming data DSS3 and a plurality of second divided dimming data DSS4 of the (n+1)-th frame. The third memory 110_4 stores a plurality of first divided dimming data DSS5 and a plurality of second divided dimming data DSS6 of the (n+2)-th frame. A plurality of first divided dimming data and a plurality of second divided dimming data of the next frame are stored in this way. In the exemplary embodiment of the present invention, the three memories (i.e., the first to third memories 110_2, 110_3 and 110_4) are the minimum number of memories required for adaptive scanning. The adaptive scanning method according to the exemplary embodiment of the present invention transmits the plurality of scan signals to the plurality of scan lines S1 to Sp twice for each frame, and when the scan signals are respectively transmitted twice, a light emission period of each light emission pixel EPX is determined by the ratio control signal RC. That is, for example, the plurality of scan lines may be sequentially applied with a plurality of first scan signals and a plurality of second scan signals during one frame period so that the plurality of scan signals may be applied to the plurality of scan lines S1 to Sp twice during the one frame period. In further detail, when the ratio control signal RC is 50%, a light emission period of a light emission pixel EPX during the first scan signal application period is the same as that of a light emission pixel EPX during the second scan signal application period. If the ratio control signal RC is 60%, a ratio of a light emission period of a light emission pixel EPX during the first scan signal application period and a light emission period of a light emission pixel EPX during the second scan signal application period is 6:4. As described, the light emission period of the light emission pixel EPX for the two scan signal applications is determined according to motion of the plurality of liquid crystal pixels PX that correspond to the light emission pixel EPX. For the adaptive scanning method, one frame includes a first field and a second field, and temporal overlap occurs between a second field of a previous frame and a first field of a current frame and between the first field and a second field of the current frame. Therefore, scan signals between frames and between the first field and the second field of each frame should not be overlapped. This will be described below in more detail with reference to FIG. 9. Accordingly, an embodiment of the present invention may include three or more memories.

The first memory 110_2 is formed of two sub-memories 110_21 and 110_22. The plurality of first divided dimming data DSS1 are stored in the first sub-memory 110_21, and the plurality of second divided dimming data DSS2 are stored in the second sub-memory 110_22. The second memory 110_3 is formed of first and second sub-memories 110_31 and 110_32, and the plurality of first divided dimming data DSS3 and the plurality of second divided dimming data DSS4 are respectively stored in the first and second sub-memories 110_31 and 110_32. The third memory 110_4 is formed of first and second sub-memories 110_41 and 110_42, and the plurality of first divided dimming data DSS5 and the plurality of second divided dimming data DSS6 are respectively stored in the first and second sub-memories 110_41 and 110_42. Here, the number of sub-memories included in the respective first to third memories 110_2, 110_3 and 110_4 may be controlled according to the number of divisions of the plurality of dimming data. The frame buffer unit 110_5 reads the plurality of first divided dimming data DSS1, DSS3, and DSS5 and the plurality of second divided dimming data DSS2, DSS4, and DSS6 respectively stored in the first to third memories 110_2, 110_3 and 110_4, and sequentially outputs the read data as light emission signals CLS.

The light emission controller 110 includes first and second counters 110_7 and 110_8, and writes a plurality of first divided dimming data DSS1, DSS3, and DSS5 and a plurality of second divided dimming data DSS2, DSS4, and DSS6 to the corresponding first and second sub-memories according to the first counting signal Count1 output from the first counter 110_7. The first and the second counters 110_7 and 110_8 generate the first counting signal Count1 and the second counting signal Count2 according to the synchronization signal Sync. Here, the synchronization signal Sync is a signal that is synchronized with a vertical synchronization signal Vsync generated by the video processor 150, and has a frequency that is substantially the same as that of the vertical synchronization signal Vsync. In addition, the synchronization signal Sync includes a pulse having a set or predetermined high-level period at a start point of each period. The first counting signal Count1 is generated in synchronization with the synchronization signal Sync, and the second counting signal Count2 may be a signal having a phase that is delayed by about a half period of the synchronization signal Sync.

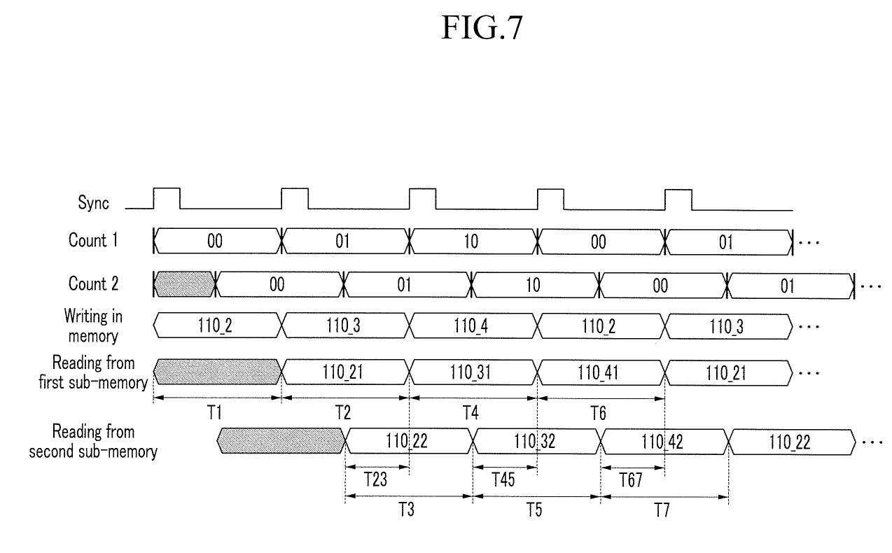

The frame buffer unit 110_5 reads a plurality of the first divided dimming data DSS1, DSS3, and DSS5 from the first sub-memories 110_21, 110_31, 110_41 of the first to the third memories 110_2-110_4 according to the first counting signal Count1. Also, the frame buffer unit 110_5 reads a plurality of the second divided dimming data DSS2, DSS4, and DSS6 from the second sub-memories 110_22, 110_32, 110_42 of the first to the third memories 110_2-110_4 according to the second counting signal Count2 output from the second counter 110_8. This will be described in further detail below with reference to FIG. 7.

The control signal generator 110_6 generates a scan driving control signal CS and a column driving control signal CC by using the light emission control signal LCS, and transmits the generated signals respectively to the scan driver 114 and the column driver 112. The scan driving control signal CS includes a scan start signal STV1 that instructs scan start for the respective plurality of scan lines S1 to Sp, and at least one clock signal that controls an output period of a scan on voltage VN. The scan driver 114 controls the generation of a plurality of the first scan signals and a plurality of the second scan signals according to the scanning start signal STV1. Here, the scanning start signal STV1 as a signal having twice the frequency for the horizontal period signal may include a pulse signal corresponding to twice the number of the scan lines during one horizontal period. Here, in the scanning start signal STV1, the second pulse controlling the start of one scan signal among a plurality of the second scan signals after the first pulse controlling the start of one scan signal among a plurality of the first scan signals, and the third pulse controlling the start of another scan signal among a plurality of the first scan signals, are sequentially and repeatedly generated. In an exemplary embodiment of the present invention, the interval between the first pulse and the second pulse, and the time interval between the second pulse and the third pulse, are different from each other.

The column driver 112 transfers the plurality of light emitting signals CLS to the plurality of column lines C1-Cq corresponding to the plurality of pixels EPX of one row according to the light emission control signal CC. Here, the column driving control signal CC includes a horizontal synchronizing start signal STH1 informing the transmitting start and a load signal LOAD that applies a light emission data voltage according to the light emission signal CLS. The horizontal synchronizing start signal STH1 includes a plurality of pulses generated in synchronization with the plurality of pulses controlling the start of the plurality of the first scan signals among the plurality of pulses of the scanning start signal STV1, and a plurality of pulses having a time difference for a plurality of pulses controlling the start of a plurality of the second scan signals among the plurality of pulses of the scanning start signal STV1. This time difference is determined for the light emission data voltages LDV1-LDVq applied to the plurality of column lines C1-Cq corresponding to the directly previous first scan signal of the second scan signal to not overlap the time that the second scan signal is applied.

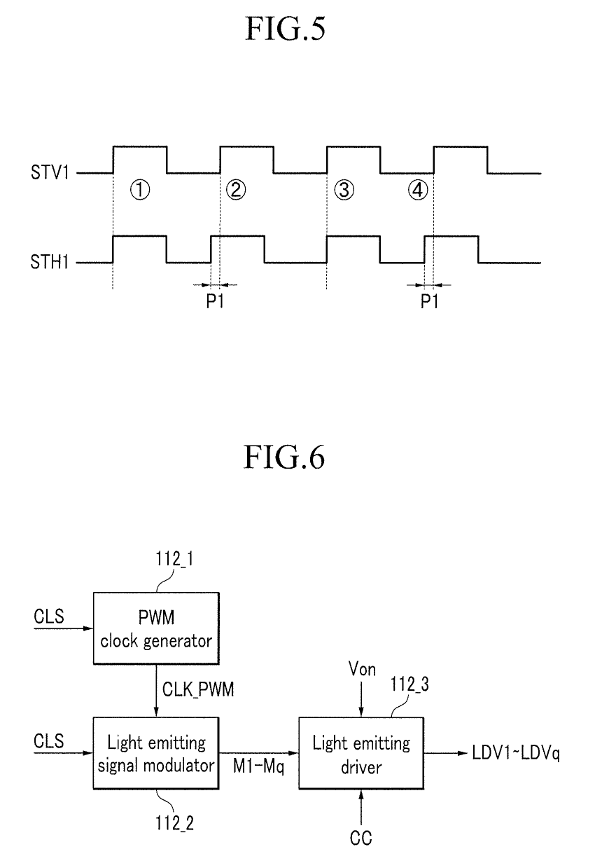

FIG. 5 is a timing diagram showing a scanning start signal STV1 input to a scan driver 114, and a horizontal synchronizing start signal STH1 input to a column driver 112, according to an exemplary embodiment of the present invention.

As shown in FIG. 5, even-numbered pulses 2 and 4 of the scanning start signal STV1 are delayed by a period P1 compared with even-numbered pulses 2 and 4 of the horizontal synchronizing start signal STH1. The scanning of the first subfield is started by the first pulse 1 of the scanning start signal STV1, and the scanning of the second subfield is started while the scanning of the first subfield is performed. In more detail, the scanning of the second subfield is started midway through the entire scanning period of the first subfield. Here, when the period in which a random light emission data voltage LDVi transmitted to the first subfield overlaps the second subfield scan signal is generated, the light emission data voltage LDVi influences the light emitting pixel emitting at the second subfield. To prevent this, in an exemplary embodiment of the present invention, the even-numbered pulse of the scanning start signal STV1 controlling the second subfield is delayed and generated at the end of the period P1. Thus, the overlapping phenomenon generated by the adaptive scanning method may be prevented.

In addition, the even-numbered pulse of the horizontal synchronizing start signal STH1 may be increased at a time in advance of the even-numbered pulses 2 and 4 of the scanning start signal STV1.

The adaptive scanning method includes at least two subfields during one frame period such that the waveform of the plurality of scan signals and the waveform of the plurality of light emission data voltages must be transmitted to the corresponding light emitting pixel in the limited time. Accordingly, the overlapping of the scan signal waveform and the waveform of the data voltage may be generated. In an embodiment of the present invention, the phase difference between the scanning start signal controlling the transmitting synchronization of the plurality of scan signals and the horizontal synchronizing start signal controlling the transmitting synchronization of the plurality of light emission data voltages is provided such that this overlapping may be prevented. In an exemplary embodiment of the present invention, the even pulses of the scanning start signal are delayed compared with the even pulses of the horizontal synchronizing start signal, or the even pulses of the horizontal synchronizing start signal are advanced compared with the even pulses of the scanning start signal. However, embodiments of the present invention are not limited thereto. If the overlapping phenomenon is prevented, the luminance of the grayscale data may ensure grayscale linearity.

FIG. 6 is a timing diagram of a column driver according to an exemplary embodiment of the present invention.

Referring to FIG. 6, the column driver 112 includes a PWM clock generator 112_1, a light emitting signal modulator 112_2 and a light emission driver 112_3. The PWM clock generator 112_1 generates a PWM clock signal CLK_PWM according to the light emitting signal CLS. Here, the corresponding relationship between the light emitting signal CLS and the PWM clock signal CLK_PWM is determined by an experimental method, and is stored to the PWM clock generator 112_1 as a lookup table. In more detail, to provide the linearity between the grayscale data of the light emitting pixel EPX included in the dimming signal and the light emitting luminance of the corresponding light emitting pixel EPX, the PWM clock signal CLK_PWM according to the light emitting signal CLS is experimentally calculated. The lookup table includes the data for the PWM clock signal CLK_PWM according to the calculated light emitting signal CLS.

The light emitting signal modulator 112_2 generates modulation light emitting signals M1-Mq for determining the light emitting period of the corresponding light emitting pixel by using the light emitting signal CLS and the corresponding PWM clock CLK_PWM. The light emission driver 112_3 stores a plurality of modulation light emitting signals M1-Mq respectively corresponding to the plurality of column lines C1-Cq, and respectively applies the plurality of light emission data voltages LDV1-LDVq having the on voltage Von during the period respectively corresponding to the plurality of modulation light emitting signals M1-Mq to the plurality of column lines C1-Cq according to the column driving control signal CC.

The display unit 116 includes the plurality of scan lines S1 to Sp that transmit scan signals, the plurality of column lines C1 to Cq, and the plurality of light emitting pixels EPX that transmit light emission data signals. Each of the plurality of light emitting pixels EPX is located in a crossing region of a corresponding one of the scan lines S1 to Sp and a corresponding one of the column lines C1 to Cq crossing the scan lines. Each of the plurality of light emitting pixels EPX according to the exemplary embodiment of the present invention is formed of a field emission array (FEA) type of electron emission element. The FEA type electron emission element includes a scan electrode, a data electrode, an electron emission region electrically connected to one of the scan and data electrodes, and a phosphor layer. The electron emission region may be made of a material having a low work function and/or a material having a high aspect ratio, e.g., a carbon-based material and/or a nanometer-sized material. The FEA type of electron emission element forms an electric field around the electron emission region by using a voltage difference between the scan electrode and the data electrode to emit electrons to excite a phosphor layer to thus emit visible light of a strength corresponding to an emission amount of electron beams.

FIG. 7 is a timing diagram showing operation of the light emission controller 110 according to an exemplary embodiment of the present invention.

Referring to FIG. 7, the first counting signal Count1 is synchronized with a rising edge of the synchronization signal Sync and is iteratively counted in an order of “00, 01, 10”, and the second counting signal Count2 is iteratively counted in an order of “00, 01, 10” with a time gap that corresponds to about a half period of the synchronization signal Sync with the first counting signal Count1. The first counting signal Count1 and the second counting signal Count2 according to the exemplary embodiment of the present invention are realized with digital data having bits that may indicate the number of the plurality of memories 110_2, 110_3 and 110_4, and is iteratively changed by a unit of the number of plurality of memories 110_2, 110_3 and 110_4. For a period T1 during which the first counting signal Count1 is “00”, the plurality of first divided dimming data DSS1 are written in the first sub-memory 110_21 of the first memory 110_2 and the plurality of second divided dimming data DSS2 are written in the second sub-memory 110_22. For a period T2 during which the first counting signal Count1 is “01”, the plurality of first divided dimming data DSS3 are written in the first sub-memory 110_31 of the second memory 110_3 and the plurality of second divided dimming data DSS4 are written in the second sub-memory 110_32. The frame buffer unit 110_5 reads the first divided dimming data DSS1 from the first sub-memory 110_21 during the period T2. For a period T3 during which the second counting signal Count2 is “01”, the frame buffer unit 110_5 reads the plurality of second divided dimming data from the second sub-memory 110_22. For a period T4 during which the first counting signal Count1 is “10”, the plurality of first divided dimming data DSS5 are written in the first sub-memory 110_41 of the third memory 110_4 and the plurality of second divided dimming data DSS6 are written in the second sub-memory 110_42. The frame buffer unit 110_5 reads the plurality of first divided dimming data DSS3 from the first sub-memory 110_31 during the period T4. For a period T5 during which the second counting signal Count2 is “10”, the frame buffer unit 110_5 reads the plurality of second divided dimming data DSS4 from the second sub-memory 110_32. For a period T6 during which the first counting signal Count1 is “00”, the plurality of first divided dimming data DSS1 are written in the first sub-memory 110_21 of the first memory 110_2 and the plurality of second divided dimming data DSS2 are written in the second sub-memory 110_22. The frame buffer unit 110_5 reads the plurality of first divided dimming data DSS5 from the first sub-memory 110_41. For a period T7 during which the second counting signal Count2 is “00”, the frame buffer unit 110_5 reads the plurality of second divided dimming data DSS6 from the second sub-memory 110_42. In this way, the plurality of first divided dimming data DSS1, DSS3, and DSS5 and the plurality of second divided dimming data DSS2, DSS4, and DSS6 that respectively correspond to each frame are output as the light emission signals CLS.

The frame buffer unit 110_5 generates the light emission signal CLS by alternately arranging the plurality of first divided dimming data DSS1, DSS3, and DSS5 and the plurality of second divided dimming data DSS2, DSS4, and DSS6 read from the respective sub-memories. That is, for a period T23 during which the period T2 and the period T3 overlap, the frame buffer unit 110_5 alternately arranges the plurality of first divided dimming data DSS1 read from the first sub-memory 110_5 and the plurality of second divided dimming data DSS2 read from the second sub-memory 110_22. For a period T45 during which the period T4 and the period T5 overlap, the frame buffer unit 1105 alternately arranges the plurality of first divided dimming data DSS3 read from the first sub-memory 110_31 and the plurality of second divided dimming data DSS4 read from the second sub-memory 110_32. In addition, for a period T67 during which the period T6 and the period T7 overlap, the frame buffer unit 110_5 alternately arranges the plurality of first divided dimming data DSS5 read from the first sub-memory 110_41 and the plurality of second divided dimming data DSS6 read from the second sub-memory 110_42. As described, the frame buffer unit 110_5 alternately arranges the first divided dimming data and the second divided dimming data because the plurality of scan signals are transmitted twice to the plurality of scan lines S1 to Sp according to the adaptive scanning method of the exemplary embodiment of the present invention.

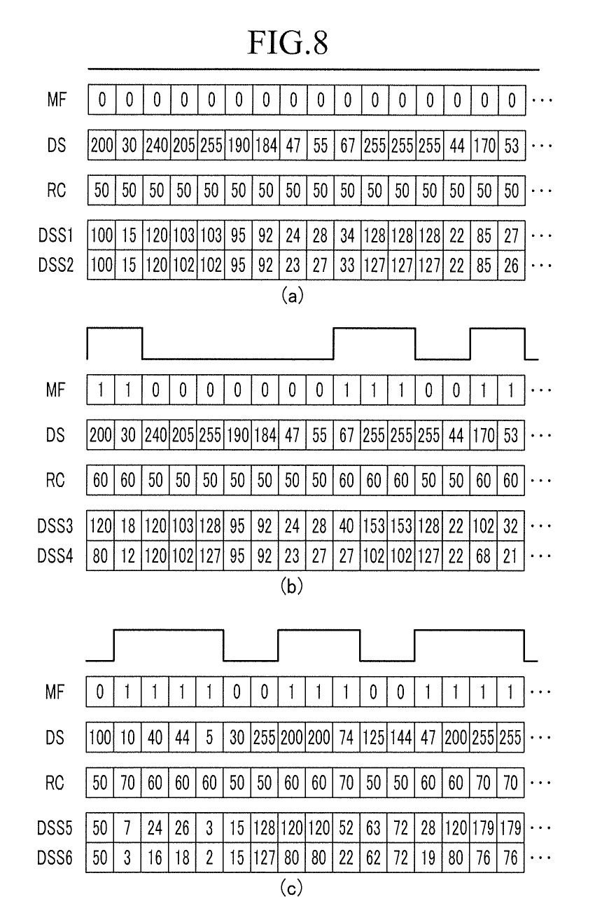

FIG. 8 shows the motion flag signal MS, the dimming signal DS, the ratio control signal RC, the plurality of first divided dimming data DSS1, DSS3, and DSS5, and the plurality of second divided dimming data DSS2, DSS4, and DSS6, according to an exemplary embodiment of the present invention.

FIG. 8 is provided to describe that the plurality of dimming data of the dimming signal DS are divided into the plurality of first divided dimming data and the plurality of second divided dimming data through signal division and a ratio operation according to the motion flag signal MS. In FIG. 8, the motion flag signal MS, the dimming signal DS, the ratio control signal RC, the plurality of first divided dimming data DSS1, DSS3, and DSS5, and the plurality of second divided dimming data DSS2, DSS4, and DSS6 are represented by a denary scale.

Referring to FIG. 8, the ratio control signal RC is generated at 50% in a region where the motion flag signal MS is at a low level (“0”) in the n-th frame (a) so that ratios of the plurality of first divided dimming data DSS1 and the plurality of second divided dimming data DSS2 respectively become 50%. For example, when dimming data in the corresponding region is 200, the plurality of first divided dimming data DSS1 become 100 and the plurality of second divided dimming data DSS2 become 100. When a motion flag signal MS of the corresponding region in the (n+1)-th frame is at a high level (“1”), the ratio control signal RC is generated at 60% so that the ratio of the plurality of first divided dimming data DSS3 is increased to 60% and the ratio of the plurality of second divided dimming data DSS4 is decreased to 40%. Then, the plurality of first divided dimming data DSS3 become 120, and the plurality of second divided dimming data DSS4 become 80. When the motion flag signal MS of the corresponding region in the (n+2)-th frame is at a low level (“0”), the ratio control signal RC is generated at 50% so that the ratio of the plurality of first divided dimming data DSS5 is decreased to 50% and the ratio of the plurality of second divided dimming data DSS6 is increased to 50%. Then, the plurality of first divided dimming data DSS5 become 100, and the plurality of second divided dimming data DSS6 become 100. In this case, although the motion flag signal MS is continuously at the low level (“0”), the ratio control signal RC is not decreased to lower than 50%, and when the motion flag signal MS is continuously at the high level (“1”), the ratio control signal RC is increased to 100%.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A light emitting device for providing a light source to a display for displaying an image according to an input video signal and an input video control signal, the light emitting device comprising:
a display unit comprising a plurality of scan lines, a plurality of column lines, and a plurality of light emission pixels for providing a light source to at least one pixel of a display, wherein the plurality of scan lines is sequentially applied with a plurality of first scan signals and a plurality of second scan signals during one frame period, and the plurality of column lines is applied with a plurality of light emission data voltages;
a controller configured to generate a plurality of dimming signals having brightness information for the plurality of light emission pixels by reading the input video signal and the input image control signal, to generate the plurality of light emission data voltages corresponding to the plurality of dimming signals, to generate a scanning start signal comprising a plurality of first pulses and a plurality of second pulses, the plurality of first pulses and the plurality of second pulses being for respectively controlling a generation time of the plurality of first scan signals and the plurality of second scan signals, and to generate a horizontal synchronizing start signal including a plurality of third pulses respectively synchronized with the plurality of first pulses and a plurality of fourth pulses having a phase differing from the plurality of second pulses;
a scan driver for sequentially applying the plurality of first scan signals and the plurality of second scan signals to the plurality of scan lines according to the scanning start signal; and
a column driver for applying the plurality of light emission data voltages to the plurality of column lines according to the horizontal synchronizing start signal.

2. The light emitting device of claim 1, wherein
the controller comprises:
a local brightness controller configured to generate a plurality of motion flag signals, having motion information for regions of the display, to respectively correspond to the plurality of light emission pixels, and to generate a plurality of ratio control signals having division ratio information of the plurality of dimming signals respectively according to the plurality of motion flag signals; and
a light emission controller configured to divide the plurality of dimming signals to be a plurality of first divided dimming data corresponding to the plurality of first scan signals and a plurality of second divided dimming data corresponding to the plurality of second scan signals according to the plurality of ratio control signals.

3. The light emitting device of claim 2, wherein the local brightness controller is configured to increase or decrease a ratio of the plurality of first divided dimming data and the plurality of second divided dimming data with respect to the plurality of dimming signals according to the plurality of motion flag signals.

4. The light emitting device of claim 2, wherein the local brightness controller is configured to generate a synchronization signal for dividing the plurality of dimming signals by utilizing the input video control signal and a light emission control signal for controlling light emission of the plurality of light emission pixels.

5. The light emitting device of claim 4, wherein
the light emission controller comprises:
a data processor configured to divide the plurality of dimming signals to be the plurality of first divided data and the plurality of second divided dimming data according to the plurality of ratio control signals;
a plurality of memories respectively comprising a first sub-memory and a second sub-memory in which the plurality of first divided dimming data and the plurality of second divided dimming data are configured to be respectively stored by one frame unit; and
a frame buffer unit configured to selectively read or write the plurality of first divided dimming data and the plurality of second divided dimming data from the plurality of memories according to a first counting signal and a second counting signal generated in accordance with the synchronization signal.

6. The light emitting device of claim 5, wherein:
the frame buffer unit is configured to synchronize the first counting signal in accordance with the synchronization signal, and synchronize the second counting signal such that the second counting signal is delayed for about a half period with respect to the first counting signal; and
the first counting signal and the second counting signal comprise digital data for indicating a number of the plurality of memories and are configured to be iteratively changed by the number of the plurality of memories.

7. The light emitting device of claim 5, wherein
the frame buffer unit is configured to write the plurality of first divided dimming data and the plurality of second divided dimming data in an order of the plurality of memories according to the first counting signal.

8. The light emitting device of claim 5, wherein
the frame buffer unit is configured to read the plurality of first divided dimming data from a first memory that has finished writing the plurality of first divided dimming data and the plurality of second divided dimming data among the plurality of memories according to the first counting signal, and is configured to read the plurality of second divided dimming data from the first memory according to the second counting signal.

9. The light emitting device of claim 8, wherein
the frame buffer unit is configured to alternately read the plurality of first divided dimming data and the plurality of second divided dimming data.

10. The light emitting device of claim 5, wherein
the light emission controller further comprises a control signal generator for generating a scan driving control signal and a column driving control signal by utilizing the light emission control signal.

11. The light emitting device of claim 10, further comprising:
a scan driver for applying the plurality of first scan signals and the plurality of second scan signals to the plurality of scan lines according to the scan driving control signal.

12. The light emitting device of claim 11, wherein
each frame period is divided into at least two fields, and the scan driver is configured to sequentially apply the plurality of first scan signals during a first field of the at least two fields to the plurality of scan lines and sequentially apply the plurality of second scan signals during a second field of the at least two fields to the plurality of scan lines.

13. The light emitting device of claim 12, wherein
the first field comprises a period during which the scan driver is configured to alternately apply the plurality of first scan signals of a current frame and the plurality of second scan signals of a frame directly previous the current frame.

14. The light emitting device of claim 12, wherein
the second field comprises a period in which the scan driver is configured to alternately apply the plurality of second scan signals and the plurality of first scan signals of a current frame.

15. The light emitting device of claim 10, further comprising
a column driver configured to apply a light emission data voltage of the plurality of light emission data voltages to the plurality of column lines corresponding to the plurality of first divided dimming data and the plurality of second divided dimming data according to the column driving control signal.

16. A driving method of a light emitting device comprising a plurality of light emission pixels for providing a light source to at least one pixel of a display configured to display an image according to an input video signal and an input video control signal, a plurality of scan lines, and a plurality of column lines, the method comprising:
generating a dimming signal having brightness information for the plurality of light emission pixels by reading the input video signal and the input image control signal;
generating a plurality of light emission data voltages corresponding to the dimming signal;
generating a scanning start signal comprising a plurality of first pulses and a plurality of second pulses for respectively controlling a generation time of a plurality of first scan signals and a plurality of second scan signals applied to the plurality of scan lines; and
generating a horizontal synchronizing start signal comprising a plurality of third pulses respectively synchronized with the plurality of first pulses for controlling a time for applying the plurality of light emission data voltages to the plurality of scan lines, and a plurality of fourth pulses having a phase differing from the second pulses.

17. The method of claim 16, wherein
the generating of the dimming signal having the brightness information comprises:
generating a plurality of motion flag signals having motion information for regions of the display, to respectively correspond to the plurality of light emission pixels;
generating a plurality of ratio control signals having division ratio information of the dimming signal according to the plurality of motion flag signals; and
dividing the dimming signal to be a plurality of first divided dimming data corresponding to the first scan signal and a plurality of second divided dimming data corresponding to the second scan signal according to the plurality of ratio control signals,
wherein the dimming signal comprises the plurality of first dividing dimming data and the plurality of second divided dimming data.

18. The method of claim 17, wherein
the dividing of the dimming signal to be the plurality of first divided dimming data and the plurality of second divided dimming data comprises increasing or decreasing a ratio of the plurality of first divided dimming data with respect to the dimming signal according to the plurality of motion flag signals.

19. The method of claim 17, wherein
the input video control signal comprises a vertical synchronization signal, and the driving method further comprises:
generating a synchronization signal that is synchronized with the vertical synchronization signal;
generating a first counting signal synchronized with the synchronization signal and generating a second counting signal synchronized at a time that is delayed by about a half period from the synchronization signal; and
selectively reading and writing the plurality of first divided dimming data and the plurality of second divided dimming data according to the first counting signal and the second counting signal.

20. The method of claim 19, wherein
the selective reading and writing of the plurality of first divided dimming data and the plurality of second divided dimming data comprises:
writing the plurality of first divided dimming data and the plurality of second divided dimming data of one frame unit according to the first counting signal;
reading the plurality of first divided dimming data according to the first counting signal when the writing of the plurality of first divided dimming data and the plurality of second divided dimming data of one frame unit is finished; and
reading the plurality of second divided dimming data according to the second counting signal,
wherein the alternately reading of the plurality of first divided dimming data and the plurality of second divided dimming data is repeated.
